(19) United States
(12) Patent Application Publication
(10) Pub. No.: US 2004/0243424 A1
(43) Pub. Date: Dec. 2, 2004

(54) Method and system for providing consulting service using virtual item and incentive

(76) Inventor: Young-Seok Jeong, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/486,251

(22) PCT Filed: Aug. 9, 2002
(86) PCT No.: PCT/KR02/01528

(30) Foreign Application Priority Data
Aug. 10, 2001 (KR) 2001-48430

(51) Int. Cl. G06F 17/60

(52) U.S. Cl. 705/1; 705/14; 705/10

(57) ABSTRACT

The present invention relates to methods and systems for marketing by a medium of virtual items. More particularly, the present invention relates to methods and systems or combining the merits of real life and cyber space by importing a concept of an item from the cyber space, and as a result, providing various services, such as life design, education, entertainment and consulting, which are closely related to the life style of a user. According to the present invention, a method providing consulting service using a virtual item and an incentive, and an apparatus and a system thereof are provided, which receives a life-design request, retrieves the user's goods purchase information and an acquisition item which are stored beforehand from a database, wherein the acquisition item is the user's virtual item acquired by the user's goods purchase, analyzes the goods purchase information and the acquisition item by using a predetermined life-design method in order to produce a life-design result and transmits the life-design result to the user.

### TECHNICAL FIELD OF THE INVENTION

The present invention relates to methods and systems for marketing by a medium of virtual items. More particularly, the present invention relates to methods and systems for combining merits of real life and cyber space by importing the concept of an item from the cyber space, and as a result, providing various services, such as life design, education, entertainment and consulting, which are closely related to the life style of a user.

### BACKGROUND OF THE INVENTION

Since conventional e-commerce, marketing, education and consulting utilize only current phenomenon, they cannot provide a future life design according to the characteristics of each person.

Also, since the conventional life style consulting method provides customer analysis and life management by analyzing only current information of a customer, the current method cannot provide real and detailed life consulting that favorite articles related to the daily life, goods, plans for purchasing goods and services are applied to.

Also, conventional e-commerce and consulting services have not developed in combination between cyber space having bi-directional characteristics and the real world but developed as an imitation of real world, so they could not have a synergy effect resulting from the combination.

Also, the conventional life style consulting method is faced with “a cultural anomie”, so the real world and cyber space cannot be combined with each other, and services are in the same situation of the real world and cyber space.

### SUMMARY OF THE INVENTION

Accordingly, the object of the present invention is to provide a method and system for providing consulting service using virtual item and incentive, which import a virtual item equivalent to an actual object and an abstract concept, as a medium connecting the real world and cyber space, and provide various services including a valuation service and a consulting service according to the characteristics of each person through the virtual item, and by making a purchase plan for real assets and financial goods into an item, a total consulting service about personal life such as financial technology and an analysis regarding capital requirement.

Another object of the present invention is to provide a method and system for providing consulting service using virtual item and incentive, which can cause a synergy effect, through combining real world and cyber space having a feature of being bi-directional in conventional e-commerce, education, consulting service, etc.

Still another object of the present invention is to provide a method and system for providing consulting service using virtual item and incentive, which by importing a virtual item, can provide a life style design service according to the characteristics of a person and a specialized personal service to a user in conventional e-commerce, education, consulting service, etc.

Still another object of the present invention is to provide a method and system for providing consulting service using virtual item and incentive, which by providing a new virtual item system and a life style consulting service, can allow the Internet to be utilized in many areas of life generally.

Still another object of the present invention is to provide a method and system for providing consulting service using virtual item and incentive, which through a virtual item equivalent to an actual object, can provide valuation/consulting service for real asset and efficient management of the real asset to the user.

Still another object of the present invention is to provide a method and system for providing consulting service using virtual item and incentive, which through purchasing a virtual item equivalent to the actual object beforehand, can provide a total consulting service related to the whole life of a person by converting financial goods into an item, e.g., a schedule for purchasing real asset, personalized financial technology, and an analysis of capital requirement.

To achieve the aforementioned objects according to the preferred embodiment of the present invention, a method providing consulting service using virtual item and incentive, and an apparatus and a system thereof are provided, which receives a life-design request, retrieves the user's goods purchase information and an acquisition item which are stored beforehand from a database, wherein the acquisition item is the user's virtual item acquired by the user's goods purchase, analyzes the goods purchase information and the acquisition item by using a predetermined life-design method in order to produce a life-design result and transmits the life-design result to the user.

The virtual item is a two or three-dimensional image having unique characteristics and a unique function, wherein the unique characteristics and the unique function are selected from motion, sound, taste, scent and texture, and the virtual item is equivalent to an actual object and an abstract concept.

The method provides a benefit to the user according to a tenure of the acquisition item.

The method handles depreciation about performance of the acquisition item according to the endurance period of the acquisition item.

The method provides an incentive to the user when the user purchases the actual object or the virtual item according to the management status and the bringing up status of the acquisition item.

The acquisition item can be succeeded to and exchanged by parity.

When the characteristic of the acquisition item represents an ability of a person, the method provides an item having an ability below the equivalence for free.

When the characteristic of the acquisition item is services, the method provides the remaining functions after alienation to be utilized by the user.

The acquisition item can be jointly possessed by a plurality of users or be held by being segmentalized into the interest by each user.

The selection of an expense and a use time of the acquisition item can be different according to the time slot, the low-demand season, and the high-demand season.

The method provides a life-style design service having at least one selected from a group consisting of advertisement, education, consulting, financial technology, and goods recommendation according to the analysis of the acquisition item.

To achieve the aforementioned objects according to another preferred embodiment of the present invention, a method providing consulting service using virtual item and incentive and an apparatus and a system thereof are provided, which receives a consulting request from a user, retrieves the user's reservation item stored beforehand from a database, wherein the reservation item is a virtual item that the user purchased beforehand corresponding to the goods that the user intended to purchase, analyzes the reservation item by using a predetermined consulting information method in order to produce a purchase-plan design and an expense of purchasing the goods corresponding to the reservation item, and transmits the consulting information having the purchase-plan design and the expense to the user.

The virtual item is a two or three-dimensional image having unique characteristics and a unique function, wherein the unique characteristics and the unique function are selected from motion, sound, taste, scent and texture, and the virtual item is equivalent to an actual object and an abstract concept.

The method provides a benefit to the user according to a tenure of the reservation item.

The method handles depreciation about performance of the reservation item according to the endurance period of the reservation item.

The method provides an incentive to the user when the user purchases the actual object or the virtual item according to the management status and the bringing up status of the reservation item.

The reservation item can be succeeded to and exchanged by parity.

When the characteristic of the reservation item represents an ability of a person, the method provides an item having an ability below the equivalence for free.

When the characteristic of the acquisition item is services, the method provides the remaining functions after alienation to be utilized by the user.

The reservation item can be jointly possessed by a plurality of users or be held by being segmentalized into the interest by each user.

An expense and a use time of the reservation item can be selected differently according to the time slot, the low-demand season, and the high-demand season.

The method provides a life-style design service having at least one selected from a group consisting of advertisement, education, consulting, financial technology, and goods recommendation according to the analysis of the reservation item.

The method leases the actual object corresponding to the reservation item to the user free of charge or for some commission payment.

The method provides a predetermined percentage discount when the user purchases the actual object corresponding to the reservation item.

### BRIEF DESCRIPTION OF THE DRAWINGS

FIG. 1 represents a schematic diagram of a marketing system that provides imagination item and incentive offer in accordance with one preferred embodiment of the present invention.

FIG. 2 represents the kind of imagination item in accordance with one preferred embodiment of the present invention.

FIG. 3 represents the relation between an actual object and item in accordance with one preferred embodiment of the present invention.

FIG. 4 represents a structure of reservation-item-purchase screen in accordance with one preferred embodiment of the present invention.

FIG. 5 is a flowchart illustrating the process that provides the goods purchase settlement through a shopping mall in accordance with one preferred embodiment of the present invention.

FIG. 6 is a flowchart illustrating the process that provides purchase settlement for goods offered together item through an offline member shop in accordance with one preferred embodiment of the present invention.

FIG. 7 represents a flowchart illustrating the process that provides purchase settlement for goods offered together item through an offline member store in accordance with another preferred embodiment of the present invention.

FIG. 8 is a flowchart illustrating the process that provides reservation item purchase settlement in accordance with one preferred embodiment of the present invention.

FIG. 9 is a flowchart illustrating the process that provides service corresponding to user's purchase goods and acquisition item in the item server and a portal server cooperating with the item server in accordance with one preferred embodiment of the present invention.

FIG. 10 is a flowchart illustrating the process that provides reservation goods purchase settlement by referring to the user's item reservation information in accordance with one preferred embodiment of the present invention.

FIG. 11 is a flowchart illustrating the process of providing a life design and a purchase plan design by referring to user's goods purchase information, item acquisition information, and item reservation information in accordance with one preferred embodiment of the present invention.

FIG. 12 represents the structure of item database in accordance with one preferred embodiment of the present invention.

FIG. 13 represents the structure of consulting database in accordance with one preferred embodiment of the present invention.

FIG. 14 represents the structure of item table in accordance with one preferred embodiment of the present invention.

FIG. 15 represents the structure of goods purchase particulars table in accordance with one preferred embodiment of the present invention.

FIG. 16 represents the structure of acquisition item table in accordance with one preferred embodiment of the present invention.

FIG. 17 represents the structure of reservation item table in accordance with one preferred embodiment of the present invention.

FIG. 18 represents the structure of member information table in accordance with one preferred embodiment of the present invention.

FIG. 19 represents the structure of life design table in accordance with one preferred embodiment of the present invention.

FIG. 20 represents the structure of purchase plan table in accordance with one preferred embodiment of the present invention.

FIG. 21 represents the structure of required money table in accordance with one preferred embodiment of the present invention.

<A list of the reference numbers identifying major parts shown in the drawings>

101: Item server

103: Database server

105: Shopping mall server (hereinafter 105a, . . . 105n will be indicated as 105)

109: Goods delivery company

111: Settlement company

113: Offline member shop

115: User computer

121: Item database

123: Consulting database

Embodiment

Hereinafter, the preferred embodiment of the present invention will be described in detail with the accompanying drawings.

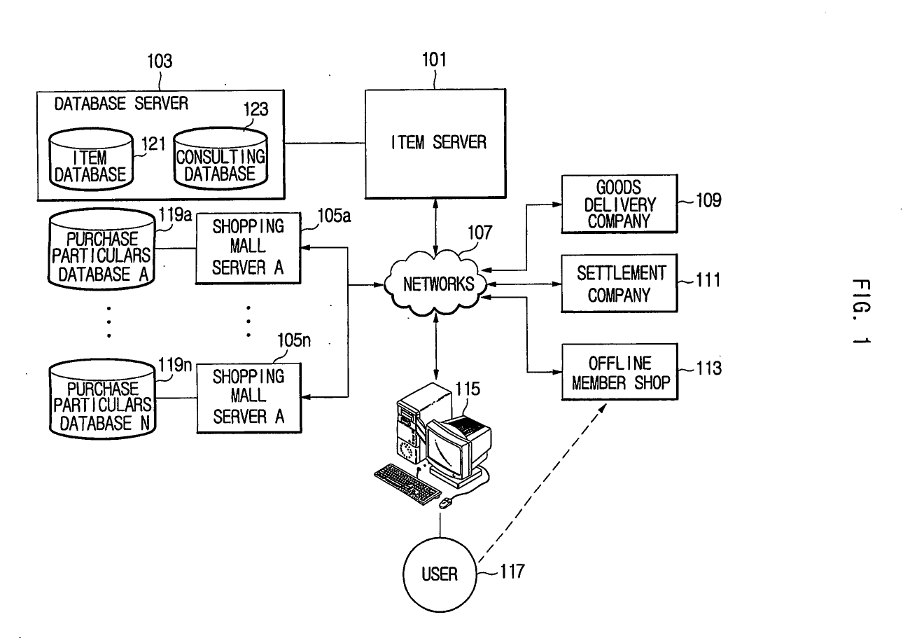

FIG. 1 represents a schematic diagram of a marketing system that provides imagination item and incentive offer in accordance with one preferred embodiment of the present invention.

Referring to FIG. 1, the item server 101 is connected to a database server 103 comprising an item database 121 and a consulting database 123.

A user terminal 115 and a terminal of an off-line member store 113(not shown) are connected to the settlement company 111 and the item server 101 through networks 107.

The user 117 can purchase goods after accessing a shopping mall server 105 and at this time, if the goods are provided together with an item, then the goods purchase particulars and item information of the acquired item are transmitted to the item server 101. On receiving the goods purchase particulars and item information, the item server 101 stores them in the item database 121.

Also, when the user 117 purchases goods provided together with an item in the off-line member store 113, the goods purchase particulars and item information of the acquired item are transmitted to the item server 101 to be stored in the item database 121.

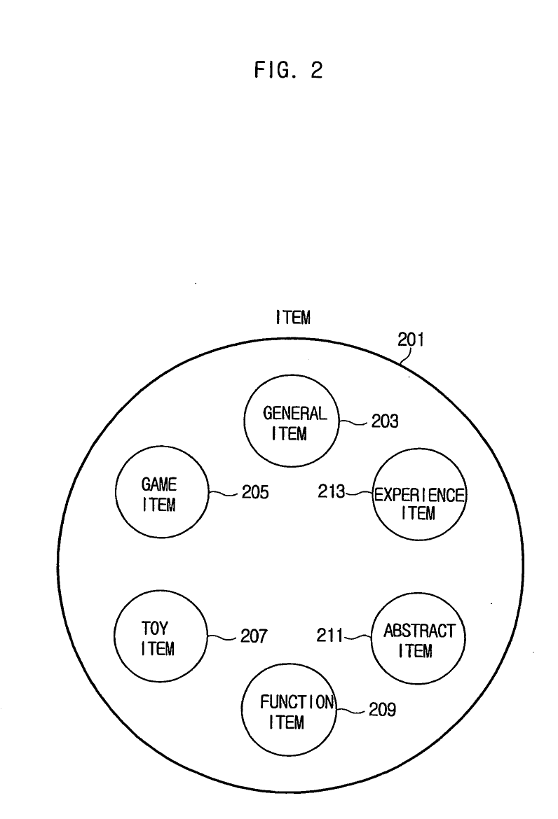

That is, by purchasing goods, the user 117 can acquire an item that may be used on the Internet, etc., and use the acquired item. The kind and functions of the item will be described with FIG. 2.

Also, the user 117 reserves an item(hereinafter, “reservation item”) corresponding to goods that he wants to purchase in the future with a small amount of money and is awarded a price discount according to the extent of the number of items and tenure of the item. At this time, information of the reservation item may be stored in the item database 121.

The item server 101 can grasp the user's 117 interest by use of the goods purchase information and acquisition item information stored in the item database 121, set up a purchase plan, and produce money required to purchase.

Through the aforementioned system that provides the services and a plurality of merits closely related to the life style of the user 117 and combines systematic life design with education, entertainment and consulting factors, the service that can be the basis of a beneficial lifestyle will be provided to the user 117.

Through the method for providing consulting service using virtual item and incentive in accordance with the present invention, the user 117 can be provided with a future vision by comparing a man having a similar age and profession with him/herself, understand the present position of him/herself by personal analysis information, statistical information, database information analysis and so on, and manage his/her profile. And as a result, the user can have a consulting service for a life schedule.

Also, by analyzing information of the senior citizens in life and comparing it with the user's information, the system according to the present invention can provide a service that simulates the present state of the user and the future state, that is 5 or 10 years later, of the user through the present state of the senior citizen who has experienced the life similar to that of the user. Here, the senior citizens in life are a population selected from members by determining matching information from member information, such as age, scholarly attainments, occupation, gender, location, etc., stored in a database and analyzing the determined matching information according to the predetermined matching ratio. The occupational classification in common use can be used. For example, occupational sections can be telecommunication, IT, manufacturing, distribution, financing and service. Chapters of financial section can be banking, insurance, securities and investment. And, headings of securities can be investment consultant, CFA, fund manager and so on.

According to the life design of the present invention, a child can play with items of cyber space from childhood, so a teacher or parents can use the result of the present invention as materials to guide behavior development of the child. Also, the result of the present invention can be used as fundamental information for future life design as he/she grows up. Since his/her toys, commodities received from parents, and items that he/she gave to friend, etc., are represented visually, the educational effects are highly expected.

The result from the life design can be an education schedule, house purchase, plan for furniture arrangement, leisure plan, etc., and can be visualized by virtual items or graphs.

FIG. 2 represents the kind of imagination item in accordance with one preferred embodiment of the present invention.

Referring to FIG. 2, the virtual item 201 matched one-to-one to an actual object can be classified into a general item 203, a game item 205, a toy item 207, a function item 209, an abstract item 211, and an experience item 213.

The virtual items can be used in games, and if the virtual items have some functions of TV, DVD player, and/or CD player, these functions can be demonstrated in cyber space. The same items can be priced differently according to the function and endurance period.

By virtue of the purchased virtual items, a user can purchase the actual object without cost or by a little commission amount. It is also possible to purchase the number of use times or a usable period. Regarding the number of use times, it is also possible to lease a plurality of equipment at the same time. The number of use times is deducted according to the number of leased equipment.

When creative items such as ideas, literary works, designs and plans are commercialized, the creators will receive a profit distribution and royalty related to the copyright.

According to the characteristics of the item, there is an incentive corresponding to the tenure and depreciation corresponding to the endurance period.

According to the periodic management and bringing-up state, when purchasing the actual object the user can receive incentives such as price discount or upgrade to higher grade.

Items can be succeeded to and exchanged by parity.

According to the characteristics of an item, depreciation corresponding to the endurance period can be different, and in some cases, some items may be classified as antiques.

According to the characteristics and tenure of an item, a user can purchase a discount coupon that can be used when buying an actual object corresponding to the item.

It is also possible to publicize and advertise with the virtual items. If the item has a function, it is also possible to lease the item to another user.

If the characteristic of an item represents an ability of a person, the user can use an item having an ability below that of his/her item for free. That is, in a certificate of qualifications having several levels, a user can use a service having the lower level than that of his/her item's level for free.

If the characteristic of the item is a service, an alienator can use the remaining functions after alienation.

According to the one-to-one trade policy when purchasing an actual object, it is possible for a user to acquire the virtual item for free. The way of acquiring virtual items varies: events, participations in advertisement, and purchases. It is also possible to acquire a virtual item corresponding to the actual object for free when purchasing an actual object.

When purchasing an actual object, the virtual item holder may have various discounts and incentives according to the characteristic of the item. For example, in the case of a pet dog, depending on how long and well he/she breeds a pet dog item in cyber space, the virtual item holder may be offered a price discount or additional feed.

There are various benefits according to the tenure of possessing an item such as a fixed amount of discount, a fixed ratio of discount, an event discount such that characteristics of a discount may be changed when participating in an event, an auction discount that provides additional discount or related goods according to the successful bid, a special discount that a purchaser can select favorable discount when purchasing goods, an additional bonus that provides related goods or expendables, an additional use time or usable period in case of service and so on.

The virtual item holder may be offered an additional discount when purchasing a discount coupon. There are two kinds of discount coupons such as a fixed amount of discount coupon and a fixed ratio discount coupon. And these coupons can be used when purchasing an actual object.

The virtual item is a two or three-dimensional image having unique characteristics and a unique function, wherein the unique characteristics and the unique function are selected from motion, sound, taste, scent and texture, and the virtual item is equivalent to an actual object and an abstract concept.

The virtual item holder may be offered a benefit when participating in a bid for purchasing goods. There may be several kinds of bids such as a public bid that exposes how much benefit is offered and a closed bid that does not expose how much benefit is offered. Additionally, the public bid exposes the maximum amount or ration of discount.

The virtual item purchaser may be offered various benefits when purchasing a bundle of goods or services, that is, actual objects or virtual items, which have similar function or use such as a goods set for infant, toy set, school things set, necessary article set for marriage, travel set, cultural lecture set, commodities set, goods set for water fun, book set for computer, dictionary set and so on.

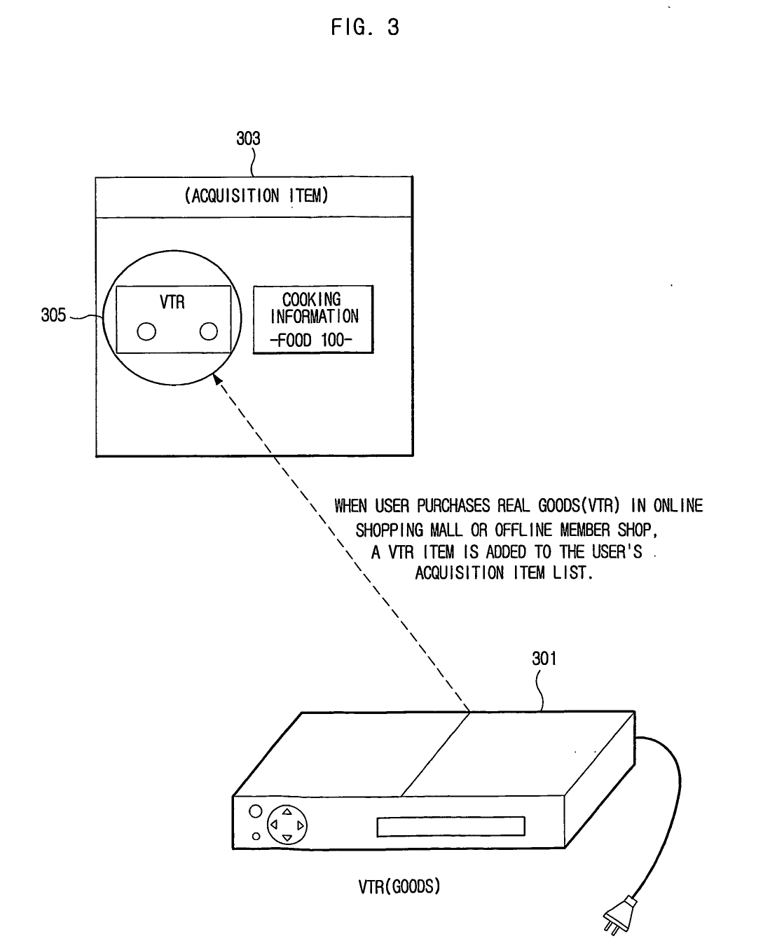

FIG. 3 represents the relation between actual object and item in accordance with one preferred embodiment of the present invention.

Referring to FIG. 3, the user 117 has purchased an actual object VTR 301 in an online shopping mall 105 or off-line member shop 113. Here, the VTR 301 is a type of goods provided with a virtual item 305, and the purchaser can view two movies on the online VTR (moving picture program) by the virtual item 305, actually a coupon.

The goods purchase particulars of user 117 are transmitted to the online shopping mall 105 or terminal(not shown) of the member shop 113 to be stored in the item database 121. The stored item(hereinafter, ‘acquisition item’) 305 can be displayed later on the acquisition item list web page 303 provided by item server 101.

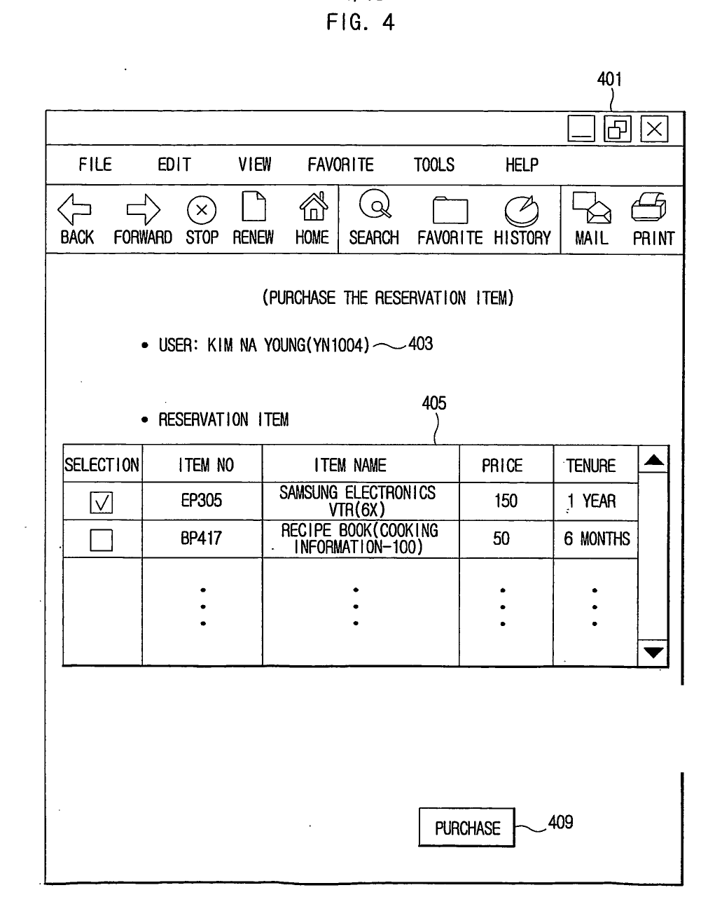

FIG. 4 represents a structure of reservation-item-purchase screen in accordance with one preferred embodiment of the present invention.

Referring to FIG. 4, the reservation-item-purchase screen 401 is provided with a user information portion 403, a reservation item list 405, a purchase button 409 and so on.

A name and ID of the user who accesses the reservation-item-purchase screen by use of web browser in user terminal 115 after subscribing to the item server 101 as a member are displayed on the user information portion.

A list of reservation items that the user 117 can purchase later in order to be offered the benefit of a discount when actually purchasing goods is displayed on the reservation item list 405.

When the user 117 checks the selection portion 407 of each reservation item and clicks the purchase button 409, the selected item is stored in the item database 121 as a reservation item.

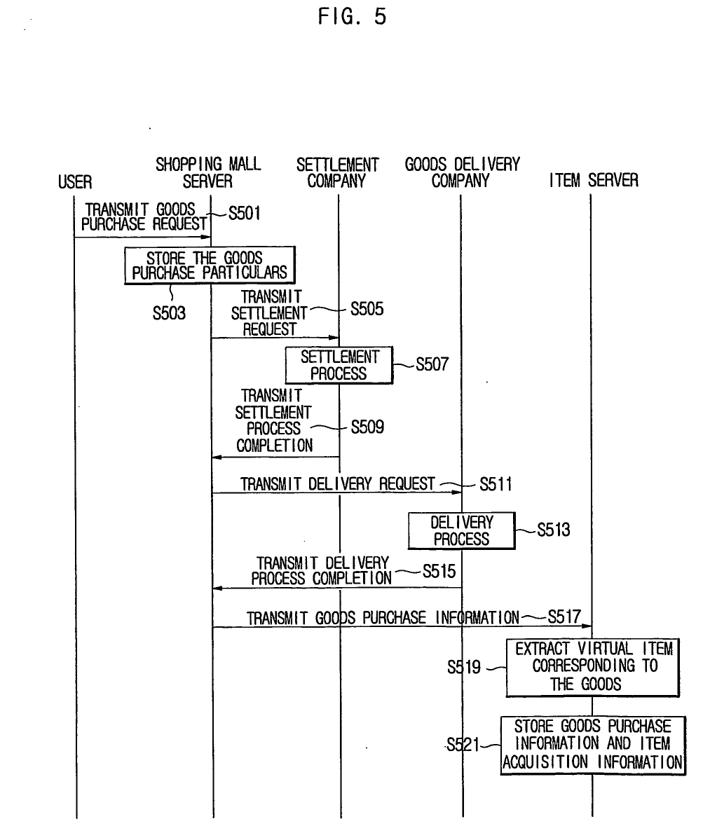

FIG. 5 is a flowchart illustrating the process that provides the goods purchase settlement through shopping mall in accordance with one preferred embodiment of the present invention.

Referring to FIG. 5, with accessing shopping mall site(not shown) provided by a shopping mall server 105 through networks 107, the user 117 searches and selects goods that he/she wants to purchase, and then transmits a goods purchase request to the shopping mall server 105(S501).

On receiving the goods purchase request, the shopping mall server 105 stores the goods purchase particulars in the purchase particulars database 119(S503) and transmits the settlement request corresponding to the goods purchase particulars to the settlement company 111(S505). On completing the settlement process, the settlement company 111 transmits the settlement process completion to the shopping mall server 105(S507).

On receiving the settlement process completion, the shopping mall server 105 transmits the delivery request corresponding to the goods to the goods delivery company 119(S511). When the goods delivery company completes the delivery process corresponding to the goods(S513) and transmits the delivery process completion to the shopping mall server 515(S515), the shopping mall server 105 transmits the goods purchase information to the item server 101(S517).

On receiving the goods purchase information, the item server 101 extracts the virtual item corresponding to the goods from the item database 121(S519). And the item database 121 stores the goods purchase information and furthermore stores the virtual item as an acquisition item(S521)

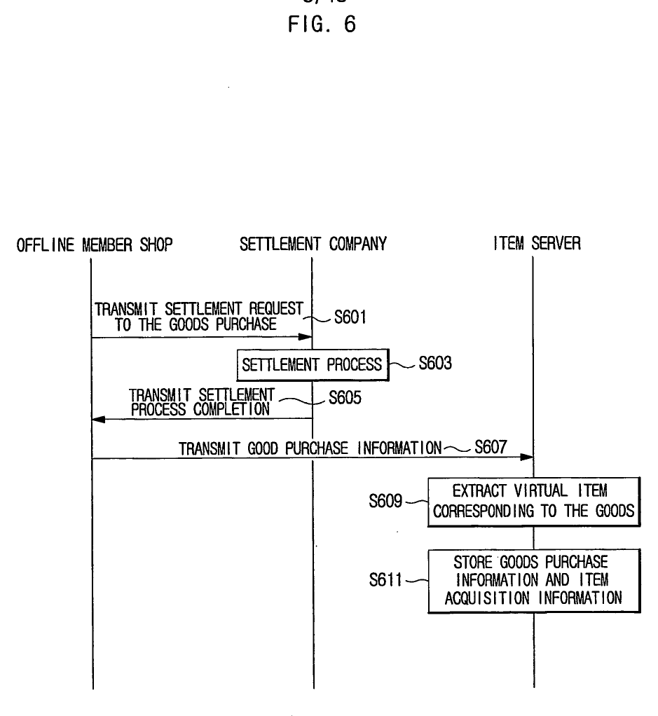

FIG. 6 is a flowchart illustrating the process that provides purchase settlement for the goods offered together item through an offline member shop in accordance with one preferred embodiment of the present invention.

Referring to FIG. 6, when the user 117 purchases goods in the offline member shop, the terminal(not shown) of the offline member shop 113 transmits the settlement request corresponding to the goods to the settlement company 111 through networks 107(S601).

The settlement company 111 completes the settlement process(S603) and transmits the settlement process completion to the terminal of the offline member shop 113(S605). On receiving the settlement completion, the terminal transmits the goods purchase information to the item server 101 through networks 107(S607)

On receiving the goods purchase information, the item server 101 extracts the virtual item corresponding to the goods from the item database 121(S609). And the item server 101 stores the goods purchase information in the item database 121 and stores the virtual item as an acquisition item(S611).

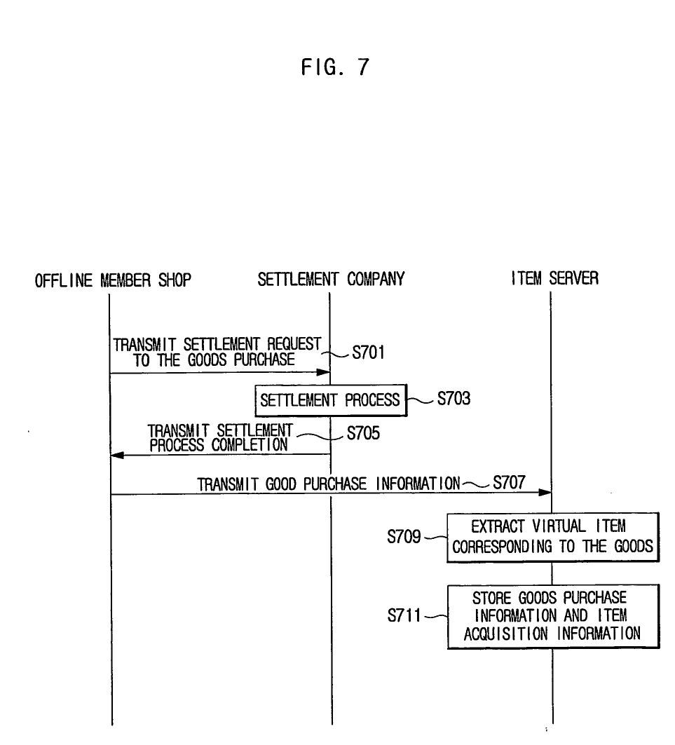

FIG. 7 represents a flowchart illustrating process that provides purchase settlement for goods offered together with item through the offline member store in accordance with another preferred embodiment of the present invention.

Referring to FIG. 7, when user 117 purchases goods in the offline member shop 113, the terminal(not shown) of the offline member shop 113 transmits the settlement request corresponding to the goods purchase to the settlement company 111 through networks 107(S701).

The settlement company 111 completes the settlement process(S703) and transmits the settlement process completion to the terminal of the offline member shop 113(S705). On receiving the settlement completion, the terminal transmits the goods purchase information to the item server 101 through networks 107(S707)

On receiving the goods purchase information, the item server 101 extracts the virtual item corresponding to the goods from the item database 121(S709). And the item server 101 stores the goods purchase information in the item database 121 and stores the virtual item as an acquisition item(S711).

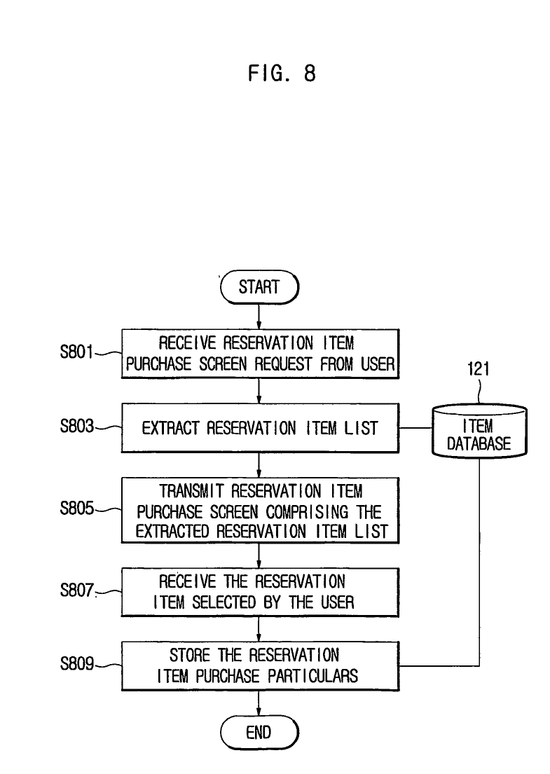

FIG. 8 is a flowchart illustrating the process that provides reservation item purchase settlement in accordance with one preferred embodiment of the present invention.

Referring to FIG. 8, when the reservation-item-purchase screen request is transmitted from the user 117(S801), the reservation item list corresponding to the request is extracted from the item database 121(S803). And the reservation-item-purchase screen having the extracted reservation item list is transmitted to the user 117(S805). When the reservation item is selected by the user by virtue of the reservation-item-purchase screen(S807), the reservation item purchase particulars are stored in the item database 121(S809).

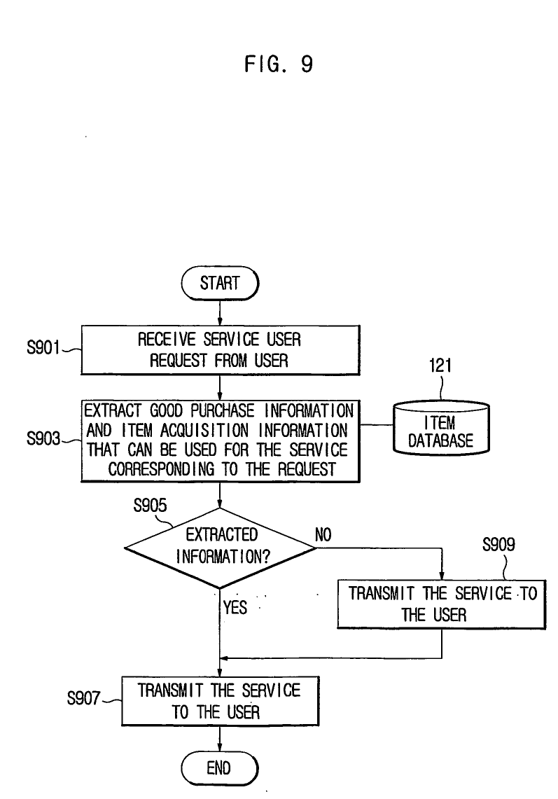

FIG. 9 is a flowchart illustrating the process that provides service corresponding to user's purchase goods and acquisition item in an item server and a portal server in cooperation with the item server in accordance with one preferred embodiment of the present invention.

Referring to FIG. 9, upon receiving a service use request from the user 117(S901), the item server 101 extracts the goods purchase information and the item acquisition information that can be used for the service corresponding to the request from the item database 121(S903).

The item server 101 determines whether or not there is extracted information(S905) and if there is extracted information, the item server 101 transmits the service to the user 117(S907). Otherwise, the item server 101 transmits an error message that there is no right to use the service(S909).

FIG. 10 is a flowchart illustrating the process that provides reservation goods purchase settlement by referring to the user's item reservation information in accordance with one preferred embodiment of the present invention.

Referring to FIG. 10, upon receiving the goods purchase request from the user 117(S1001), the shopping mall server 105 transmits the item reservation information request corresponding to the goods purchase request to the item server 101(S1003).

The item server 101 extracts the item reservation information from the item database 121 and transmits the extracted item reservation information to the shopping mall server 121(S1007). On receiving the item reservation information, the shopping mall server 105 calculates the amount of discount corresponding to the item reservation information(S1009). And the shopping mall server 105 transmits the settlement request corresponding to the discounted price to the settlement company 111(S1011).

The settlement company 111 completes the settlement process corresponding to the settlement request(S1013) to transmit the settlement process completion to the shopping mall server 105. Upon receiving the settlement process completion from the settlement company 111(S1015), the shopping mall server 105 transmits the delivery request for the goods to the delivery company 109(S1017).

After completing the delivery process according to the delivery request(S1019), the delivery company 109 transmits the delivery process completion information to the shopping mall server 105(S1021). The shopping mall server 105 transmits the goods purchase completion information to the item server 101(S1023). The item server 105 receives the goods purchase completion information and stores the goods purchase completion information in the item database 121(S1025).

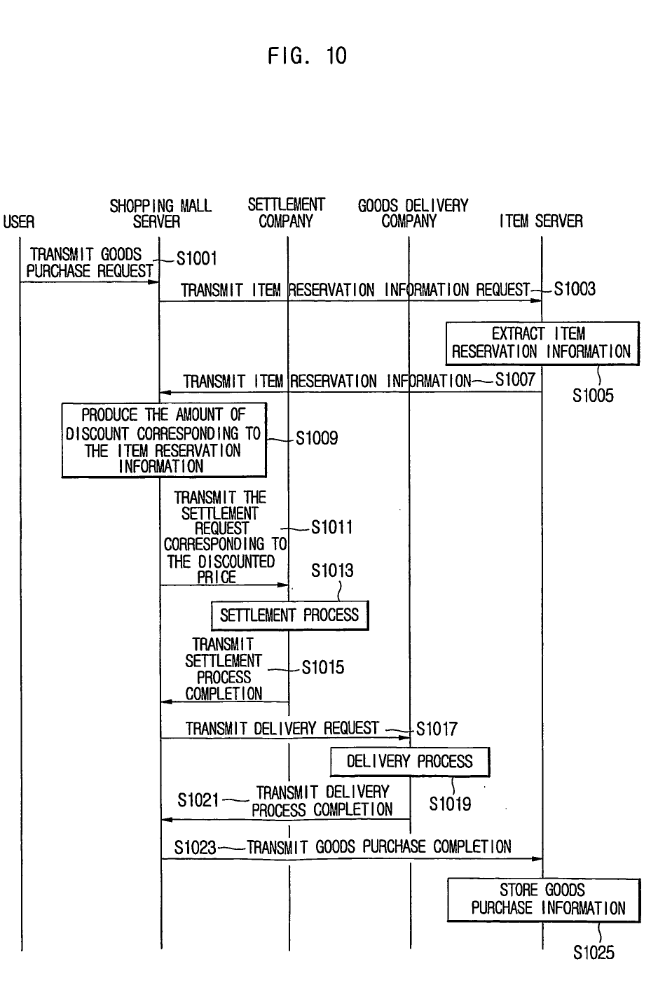

FIG. 11 is a flowchart illustrating the process of providing a life design and a purchase plan design by referring to the user's goods purchase information item acquisition information, and item reservation information in accordance with one preferred embodiment of the present invention.

Referring to FIG. 11, upon receiving a consulting request from the user 117(S1101), the item server 101 extracts the goods purchase information, the acquisition item, and the reservation item corresponding to the user 117 from the item database 121(S1103)

After completing extraction, the item server 101 analyzes the goods purchase information and the acquisition item to produce the result of the life design(S1105), and analyzes the reservation item to produce the purchase plan design and the money required to purchase(S1107). Then the item server 101 transmits the result of the life design, purchase plan design, and the money required to purchase to the user 117(S1109).

For example, the virtual items are not utilized simply to an arcade game, but rather utilized to a “to be rich” simulation game utilizing the user's acquisition items and reservation items. In this case, if a user does not want to disclose his/her private information, then the user can design a cyber life in the form of a game. In the case of being unmarried, if the user inputs hypothetical information(e.g., spouse, offspring), and analysis information, then future life design will be provided by producing the required expenses on the basis of current living expenses per person, fostering expenses and so on. Also, the analysis information and future life design will be based on probability(for example, 95% reliability, 90% reliability, etc. The interval has 100 sections and basic 5 sections). At this time, the reliability may be dependent on the distribution of the population sample, and the interval having 90% of the population will be divided into 5 sections. Reliability will be applied differently according to the deviation.

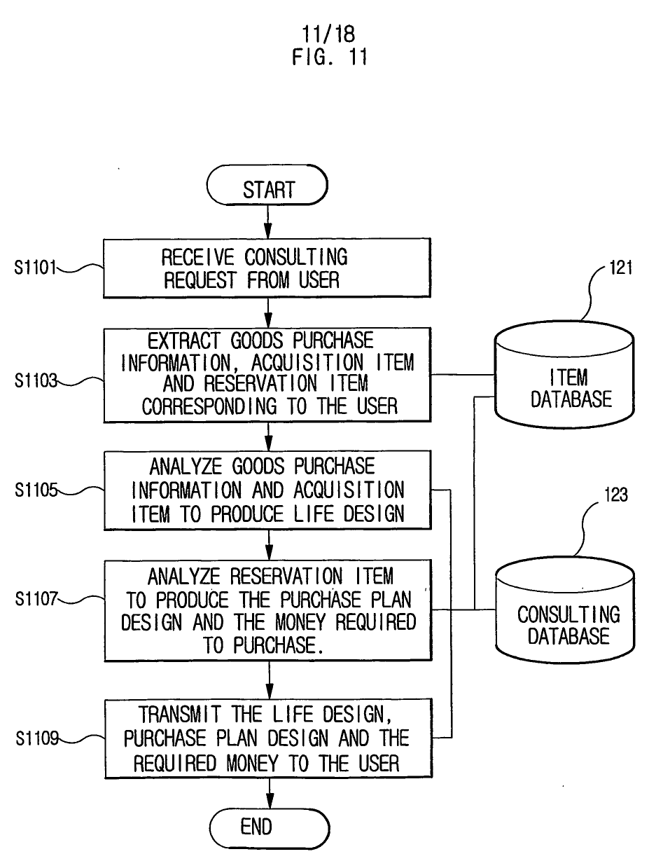

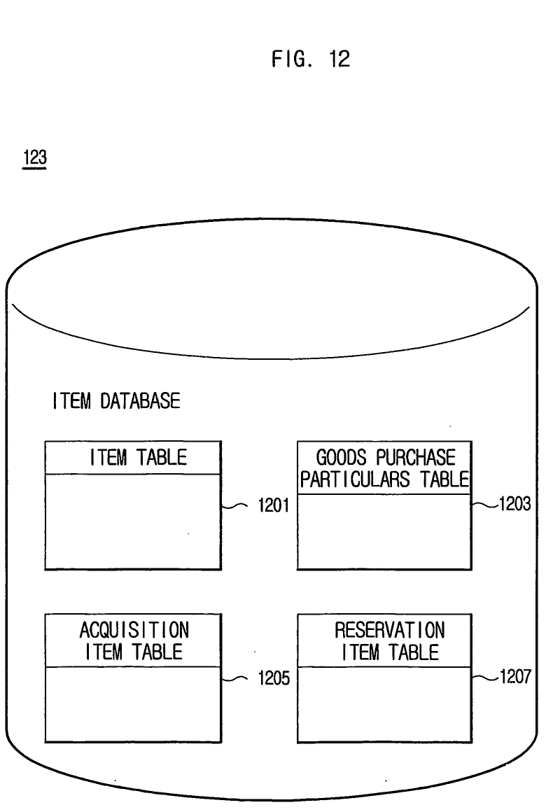

FIG. 12 represents the structure of an item database in accordance with one preferred embodiment of the present invention.

Referring to FIG. 12, the item database 121 comprises an item table 1201, goods purchase particulars table 1203, acquisition item table 1205, and reservation item table 1207.

Information of various items provided by the item server 101 is stored in the item table 1201, and information of goods purchased by the user 117 is stored in the goods purchase particulars table 1203.

Information of an item that the user acquired from purchasing goods and information of a reservation item corresponding to goods, which the user purchased reservation item beforehand in order to be offered benefit of discount are stored in the acquisition item table 1205.

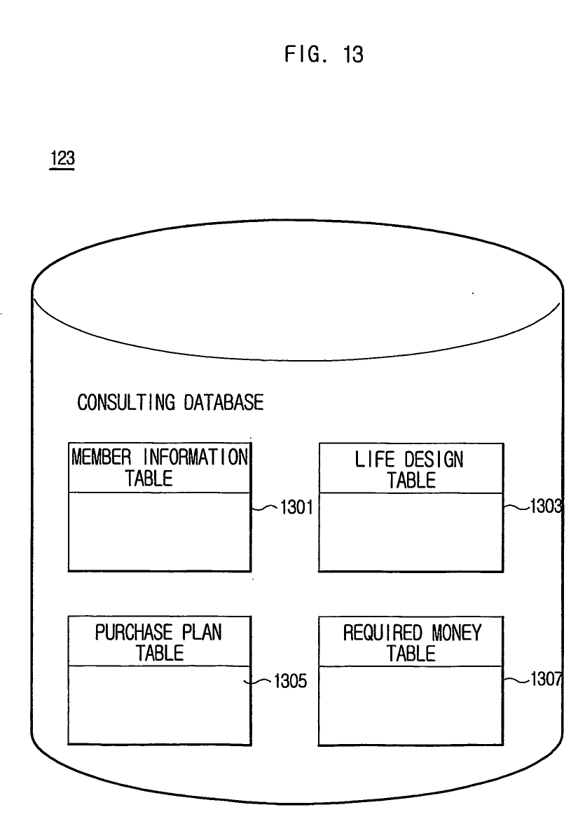

FIG. 13 represents the structure of a consulting database in accordance with one preferred embodiment of the present invention.

The consulting database comprises member information table 1301, life design table 1303, consulting table, and required money table 1307.

Information of user 117 who subscribed to the item server 101 as a member is stored in the member information table 1301, and the result of life design produced by use of the item purchase information and goods purchase information stored in each of the tables of the item database 121 is stored in the life design table 1303.

The purchase plan of user, which is produced by determining information of goods that the user 117 wants to purchase later by use of information stored in the reservation item table 1207 and is customized according to member information, is stored in the purchase plan table 1305.

The expected required money corresponding to the purchase plan stored in the purchase plan table 1305 is stored in the required money table 1307.

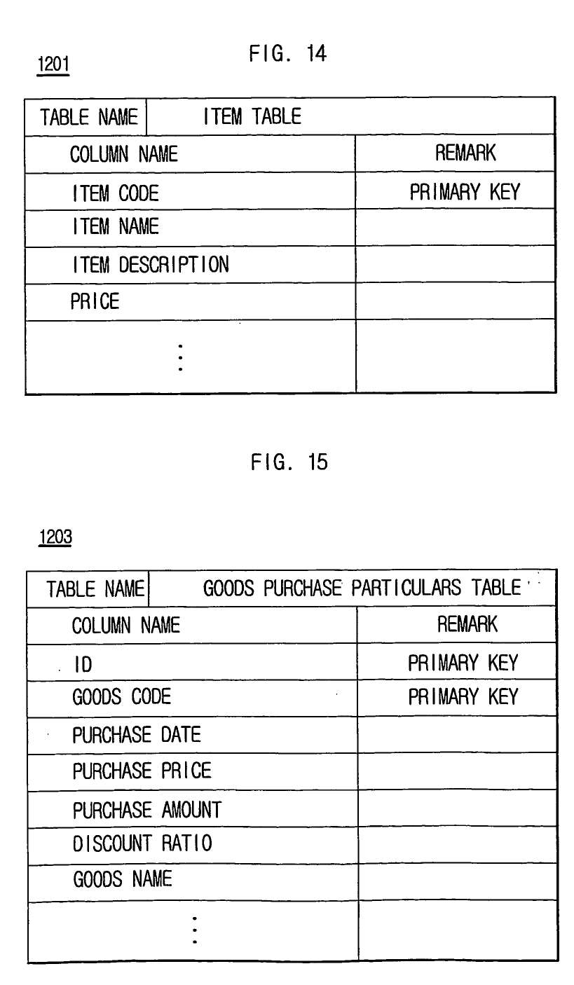

FIG. 14 represents the structure of item table in accordance with one preferred embodiment of the present invention.

Referring to FIG. 14, the item table may be provided with a plurality of columns such as item code, item name, item description, and price. The item code can be a primary key used to distinguish each datum stored in the item table 1201.

FIG. 15 represents the structures of goods purchase particulars table in accordance with one preferred embodiment of the present invention.

Referring to FIG. 15, the goods purchase particulars table 1203 is provided with a plurality of columns such as ID, goods code, purchase date, purchase price, purchase amount, discount ratio, goods name and so on. ID and goods code can be a primary key used to distinguish each datum stored in the goods purchase particulars table 1203.

FIG. 16 represents the structure of acquisition item table in accordance with one preferred embodiment of the present invention.

Referring to FIG. 16, the acquisition item table 1205 is provided with a plurality of columns such as ID, item classification code, item detail code, item name, purchase date, purchase price, purchase amount, kind of incentive and so on. ID and item code can be a primary key used to distinguish each datum stored in the acquisition item table 1205. Here, the kind of incentive can be selected from a group consisting a fixed amount of discount, a fixed ratio of discount, one more of the goods, and a coupon.

The item classification code may be, for example, general goods, experience(education, event, lecture, class), abstraction(patent, trademark, design, paper, intellectual property), game function(day or season pass, a right to use) and toy(model, “LEGO”, doll).

When the item classification code is a model, the item detail code may be, for example, a car, tank, armored motorcar, fighter, ship, submarine, train, bicycle and motorcycle. The items, similar to the goods, may be classified into sections, chapters, and headings beforehand.

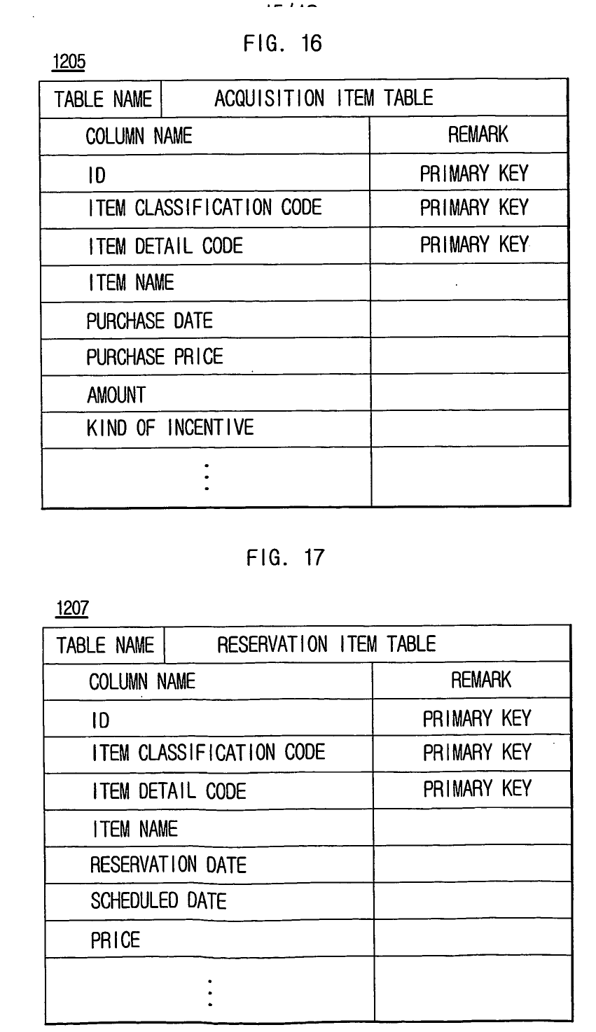

FIG. 17 represents the structure of the reservation item table in accordance with one preferred embodiment of the present invention.

Referring to FIG. 17, the reservation item table 1207 is provided with a plurality of columns such as ID, item classification code, item detail code, item name, reservation date, scheduled date, price and so on. ID and item code can be a primary key used to distinguish each datum stored in the reservation item table 1207. Here, the item code may be, for example, general goods, experience(education, event, lecture, class), abstraction(patent, trademark, design, paper, intellectual property), game function(day or season pass, a right to use) and toy(model, “LEGO”, doll). The item classification code and the item detail code are the same as described in FIG. 16.

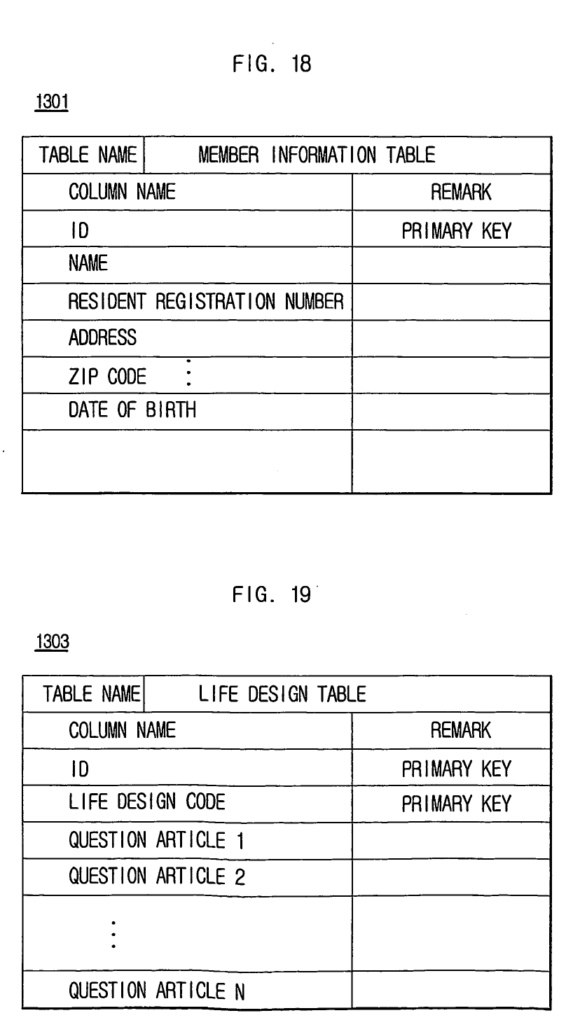

FIG. 18 represents the structure of member information table in accordance with one preferred embodiment of the present invention.

Referring to FIG. 18, the member information table 1301 is provided with a plurality of columns such as ID, name, resident registration number, address, zip code, date of birth, gender, E-mail address, telephone number, cellular number and so on. The ID can be a primary key used to distinguish each datum stored in the member information table 1301.

The personal additional information managed by each member is personal detail information, financial detail information, family detail information, company detail information and so on.

The personal detail information, for example, scholarly attainments, high school graduate code, university graduate code, certificate code, occupational category, occupation, job title in his/her company, married/unmarried status, house ownership, car ownership and so on. Other examples of the personal detail information may be amount of reading per month, amount of reading per day, newspaper subscription, the number of participations for cultural events, the number of movies viewed per month, the number of plays viewed, the number of travel trips per year and so on. Still other examples of the personal detail information may be a hobby code, bedtime, wakeup time, the number of times to exercise per week, average time of exercise per day and so on.

The financial detail information may be, for example, yearly stipend, side job, side job earnings, financial asset, real estate asset, amount of debt, yearly financial earnings, yearly financial expenses and so on. Other examples of the financial detail information may be investments in securities or bonds, start date, continuation, profitability and so on. Still other examples of financial detail information may be insurance contracting, kind of insurance, start date, expiration date and so on.

The family detail information may be, for example, father, age of father, mother, age of mother, the number of persons over 65 years including him/herself, the number of sons, the number of daughters, the number of minor children and so on. Other examples of family detail information may be spouse name, gender, age, occupation, yearly stipend and so on.

The company detail information may be, for example, company code, listed/unlisted company, career, date of joining current company, job title in his/her company, his/her duties, continuous service, length of his/her service and so on.

FIG. 19 represents the structure of life design table in accordance with one preferred embodiment of the present invention.

Referring to FIG. 19, the life design table 1303 is provided with a plurality of columns such as ID, life design code, question article 1 to N and so on. The ID and life design code can be a primary key used to distinguish each datum stored in the life design table 1303.

Here, the life design code may be cultural life, financial life, life in company, family life, etc., and accompanying questions may be stored in the question article 1 to N.

Hereinafter the case of providing a life design result to the member when the life design code is the cultural life will be described.

When the life design code is the cultural life, the question article 1 to N may be the amount of reading per month, the number of participations for education, the number of participations for exhibitions, the number of movies viewed per month, the number of trips without lodging, the number of trips with at least one lodging, monthly cultural expenses, monthly communication expenses, foreign travel, the number of times to exercise per month, item code, the number of sports games watched, the number of video rentals, amount of entertainment time per day, amount of TV being viewed per day and so on. The item may be swimming, horseback riding, skiing, snowboarding, wind surfing, etc., and the character of exercising may be the game of “go”, mediation, travel, mountain climbing, mediation in Zen, prayer and so on.

For example, let's suppose that a member is 25 years old, reads 3 books per month, views one movie per week, views 3 plays per year, goes traveling without lodging 3 times per year, goes abroad for 10 days per year, goes out for dinner one time per month, goes for exercise 3 times per week, spends 150,000 Korean won for cultural life per month and spends 100,000 won for communication service per month.

As the first method, the cultural life index will be produced by comparing the member's information with a typical Korean average.

The Korean average cultural life index is the same as follows: yearly expenses for leisure are 400,000 won, yearly expenses for spare time are 1,370,000 won, expenses for travel/outings are 750,000 won, the number of movies viewed per year is 2.66, the number of times going to exhibitions per year is 1.43, expenses for sports activities is 240,000 won, the number of books read monthly is 1.24, the number of video rentals per month is 1.65, amount of entertainment time is 0.55, amount of time watching TV is 2 hours and 50 minutes, the number of trips without lodging is 7.55, the number of trips with at least one night lodging is 1.77, the number of foreign travel trips is 0.44, and the number of sports games watched is 0.77.

At this time, the cultural life index of the member can be classified as one among ‘insufficient’, ‘poor’, ‘average’, ‘good’, and ‘excellent’. If the core articles such as yearly expenses for leisure, yearly expenses for spare time, expenses for travel/outings, the number of books read monthly, the number of times to exercise per week and the number of times for domestic travel exceed the average and others are about average, then the cultural life index of the member is classified as ‘average’. If core articles exceed average and more than 2 articles among the others exceed average, then the cultural life index of the member is classified as ‘good’. If core articles exceed average and more than 4 articles among the others exceed average, then the cultural life index of the member is classified as ‘excellent’. If 2 articles among the core articles are below average, then the cultural life index of the member is classified as ‘poor’. If 4 articles among the core articles are below average, then the cultural life index of the member is classified as ‘insufficient’.

The foreign travel, as a special article, may be replaced with the domestic travel article. If the number of days for education is more than 10 days, then it may be replaced with the number of reading books 10. And if the number of days for education is more than 30 days, then it may be replaced with the number of reading books 15.

As the second method, the cultural life index will be produced by comparing the member's information with statistics regarding the information of all the members.

The cultural life index of all the members is the same as follows: yearly expenses for leisure is 500,000 won, yearly expenses for spare time is 1,400,000 won, and expenses for travel/outings is 700,000 won

At this time, it is possible to vary the statistical reliability according to the size of the population sample, and it is also possible to produce the cultural life index of all the members by 100 members, 1,000 members, and/or 10,000 members each. In this case, the member's cultural life index may be classified as one among ‘insufficient’, ‘poor’, ‘average’, ‘good’ and ‘excellent’ according to the predetermined core articles.

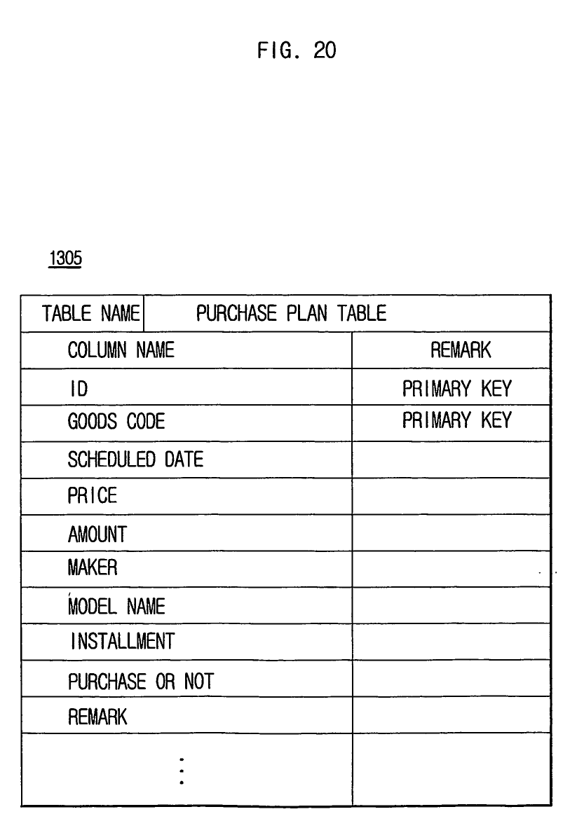

FIG. 20 represents the structure of a purchase plan table in accordance with one preferred embodiment of the present invention.

Referring to FIG. 20, the purchase plan table 1305 is provided with a plurality of columns for ID, goods code, scheduled date, price, maker, model name, installment, purchase or not, remark and so on. The ID and goods code can be a primary key used to distinguish each datum stored in the purchase plan table 1305. Here, the goods code may be classified into clothes, food, house, commodities, leisure goods, and financial goods and additionally may be classified into sections, chapters, and headings beforehand.

Leisure goods are described as an example. These include ‘001’ water fun, '002, travel, ‘003’ sports, ‘004’ car, and ‘005’ mountain climbing as sections. These are further divided into ‘001’ body building, ‘002’ ski, ‘003’ golf, ‘004’ baseball, ‘005’ football, ‘006’ basketball, and ‘007’ windsurfing as chapters of the sports section. These are further subdivided into ‘001’ ski, ‘002’ ski boots, ‘003’ ski pole, ‘004’ snowboard, ‘005’ goggle, and‘006’ ski glove as headings of the ski chapter.

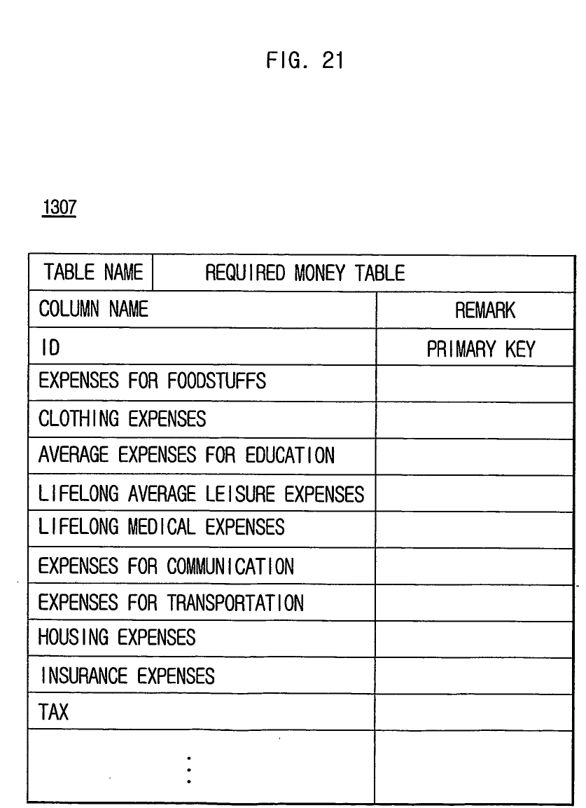

FIG. 21 represents the structure of the required money table in accordance with one preferred embodiment of the present invention.

Referring to FIG. 21, the required money table 1307 is provided with ID, expenses for foodstuffs, clothing expenses, average expenses for education, lifelong average leisure expenses, expenses for communication, medical expenses, housing expenses, insurance expenses, tax and so on. The ID can be a primary key used to distinguish each datum stored in the required money table 1307.

While the present invention has been described with reference to the preferred embodiments thereof, those skilled in the art appreciate the fact that various changes in form and detail may be made without departing from the present invention as defined in the appended claims nevertheless.

### INDUSTRIAL APPLICABILITY

As described above, the method and apparatus for marketing by providing virtual items and incentives in accordance with the present invention can provide valuation and consulting service characterized for the user by importing an item concept that, as a medium for connecting the real world with cyber space, are equivalent to real objects and abstract concepts.

Also, the method and apparatus for marketing by providing virtual items and incentives in accordance with the present invention can provide a total consulting service about personal life such as financial technology and an analysis on capital requirement by making a purchase plan for real assets and financial goods into an item.

Also, the method and apparatus for marketing by providing virtual items and incentives in accordance with the present invention can provide a synergy effect, through combining the real world and cyber space having a feature of being bi-directional in conventional e-commerce, education, consulting service, etc.

Also, the method and apparatus for marketing by providing virtual items and incentives in accordance with the present invention can provide a life style design service according to the characteristics of a person and a specialized personal service to a user in conventional e-commerce, education, consulting service, etc., by importing a virtual item.

Also, the method and apparatus for marketing by providing virtual items and incentives in accordance with the present invention can allow the Internet to be utilized in many areas of life generally by providing a new virtual item system and a life style consulting service.

Also, the method and apparatus for marketing by providing virtual items and incentives in accordance with the present invention can provide valuation/consulting service for a real asset and efficient management of the real asset to the user through a virtual item equivalent to an actual object.

Also, the method and apparatus for marketing by providing virtual items and incentives in accordance with the present invention can provide a total consulting service related to the whole life of a person by making financial goods into an item: a schedule for purchasing a real asset, personalized financial technology, and an analysis on capital requirement through purchasing a virtual item equivalent to the actual object beforehand.

1. A method for supplying consulting information to a user by using goods purchase information and virtual item information over networks, said method comprising the steps of:
receiving a life-design request;
retrieving the user's goods purchase information and an acquisition item which are stored beforehand from a database, wherein the acquisition item is the user's virtual item acquired by the user's goods purchase;
analyzing the goods purchase information and the acquisition item by using a predetermined life-design method in order to produce a life-design result; and
transmitting the life-design result to the user.

2. The method of claim 1, wherein the virtual item is a two or three-dimensional image having unique characteristics and a unique function, and the unique characteristics and the unique function are selected from motion, sound, taste, scent and texture, wherein the virtual item is equivalent to an actual object and an abstract concept.

3. The method of claim 1, wherein the method provides a benefit to the user according to a tenure of the acquisition item.

4. The method of claim 1, wherein the method handles depreciation about performance of the acquisition item according to the endurance period of the acquisition item.

5. The method of claim 1, wherein the method provides an incentive to the user when the user purchases the actual object or the virtual item according to the management status and the bringing up status of the acquisition item.

6. The method of claim 1, wherein the acquisition item can be succeeded to and exchanged by parity.

7. The method of claim 1, wherein when the characteristic of the acquisition item represents an ability of a person, and the method provides an item having an ability below an equivalence for free.

8. The method of claim 1, wherein when the characteristic of the acquisition item is services, and the method provides the remaining functions after alienation to be utilized by the user.

9. The method of claim 1, wherein the acquisition item can be jointly possessed by a plurality of users or be held by being segmentalized into an interest by each user.

10. The method of claim 1, wherein an expense and a use time of the acquisition item can be selected differently according to the time slot, the low-demand season, and the high-demand season.

11. The method of claim 1, wherein the method provides a life-style design service having at least one selected from a group consisting of advertisement, education, consulting, financial technology, and goods recommendation according to the analysis of the acquisition item.

12. A method for supplying consulting information to a user by using goods purchase information and virtual item information over networks, said method comprising the steps of:
receiving a consulting request from a user;
retrieving the user's reservation item stored beforehand from a database, wherein the reservation item is a virtual item that the user purchased beforehand corresponding to the goods that the user intended to purchase;
analyzing the reservation item by using a predetermined consulting information method in order to produce a purchase-plan design and an expense of purchasing the goods corresponding to the reservation item; and
transmitting the consulting information having the purchase-plan design and the expense to the user.

13. The method of claim 12, wherein the virtual item is a two or three-dimensional image having unique characteristics and a unique function, wherein the unique characteristics and the unique function are selected from motion, sound, taste, scent and texture, and the virtual item is equivalent to an actual object and an abstract concept.

14. The method of claim 12, wherein the method provides a benefit to the user according to a tenure of the reservation item.

15. The method of claim 12, wherein the method handles depreciation about performance of the reservation item according to the endurance period of the reservation item.

16. The method of claim 12, wherein the method provides an incentive to the user when the user purchases the actual object or the virtual item according to the management status and the bringing up status of the reservation item.

17. The method of claim 12, wherein the reservation item can be succeeded to and exchanged by parity.

18. The method of claim 12, wherein when the character of the reservation item represents an ability of a person, the method provides an item having an ability below the equivalence for free.

19. The method of claim 12, wherein when the characteristic of the acquisition item is services, and the method provides the remaining functions after alienation to be utilized by the user.

20. The method of claim 12, wherein the reservation item can be jointly possessed by a plurality of users or be held by being segmentalized into an interest by each user.

21. The method of claim 12, wherein an expense and a use time of the reservation item can be selected differently according to the time slot, the low-demand season, and the high-demand season.

22. The method of claim 12, wherein the method provides a life-style design service having at least one selected from a group consisting of advertisement, education, consulting, financial technology and goods recommendation according to the analysis of the reservation item.

23. The method of claim 12, wherein the method leases the actual object corresponding to the reservation item to the user free of charge or for some commission payment.

24. The method of claim 12, wherein the method provides a predetermined percentage discount when the user purchases the actual object corresponding to the reservation item.

25. An apparatus for supplying consulting information to a user by using goods purchase information and virtual item information over networks, said apparatus comprising:
means for receiving a life-design request;
means for retrieving the user's goods purchase information and an acquisition item which are stored beforehand from a database, wherein the acquisition item is the user's virtual item acquired by the user's goods purchase;
means for analyzing the goods purchase information and the acquisition item by using a predetermined life-design method in order to produce a life-design result; and
means for transmitting the life-design result to the user.

26. An apparatus for supplying consulting information to a user by using goods purchase information and virtual item information over networks, said apparatus comprising:
means for receiving a consulting request from a user;
means for retrieving the user's reservation item stored beforehand from a database, wherein the reservation item is a virtual item that the user purchased beforehand corresponding to the goods that the user intended to purchase;
means for analyzing the reservation item by using a predetermined consulting information method in order to produce a purchase-plan design and an expense of purchasing the goods corresponding to the reservation item; and
means for transmitting the consulting information having the purchase-plan design and the expense to the user

27. A system for supplying consulting information to a user by using goods purchase information and virtual item information over networks, said system comprising:
a storage device; and
a processor coupled to said storage device,
said storage device storing
a program for controlling said processor; and
said processor operative with said program to receive a life-design request,
retrieve the user's goods purchase information and an acquisition item which were stored beforehand from a database, wherein the acquisition item is the user's virtual item acquired by the user's goods purchase,
analyze the goods purchase information and the acquisition item by using a predetermined life-design method in order to produce a life-design result, and
transmit the life-design result to the user.

28. A system for supplying consulting information to a user by using goods purchase information and virtual item information over networks, said system comprising:
a storage device; and
a processor coupled to said storage device,
said storage device storing
a program for controlling said processor; and
said processor operative with said program to receive a consulting request from a user,
retrieve the user's reservation item stored beforehand from a database, wherein the reservation item is a virtual item that the user purchased beforehand corresponding to the goods that the user intended to purchase,
analyze the reservation item by using a predetermined consulting information method in order to produce a purchase-plan design and an expense of purchasing the goods corresponding to the reservation item, and
transmit the consulting information having the purchase-plan design and the expense to the user.
